(19) United States
(12) Patent Application Publication
(10) Pub. No.: US 2004/0190149 A1
(43) Pub. Date: Sep. 30, 2004

(54) Image projection system and polarizing beam splitter

(76) Inventors: Jan-Tian Lian, Keelung City (TW); June-Jei Huang, Taoyuan Hsien (TW)

Correspondence Address: BIRCH STEWART KOLASCH & BIRCH, PO BOX 747, FALLS CHURCH, VA, 22040-0747, US

(21) Appl. No.: 10/776,523

(22) Filed: Feb. 12, 2004

(30) Foreign Application Priority Data
Mar. 25, 2003 (TW) 092106606

(51) Int. Cl. G02B 27/14

(52) U.S. Cl. 359/629

(57) ABSTRACT

An image projection system utilizing a convergent light source and an optical polarizing module. The optical polarizing module includes a wire grid polarizing beam splitter (WG-PBS), reflecting S-polarized light, forming a first beam, and transmitting P-polarized light. A mirror is disposed near the WG-PBS at a predetermined acute angle to reflect light with S-polarization, passing through the WG-PBS again and forming a second beam. A first lens array couples the first and second beams and individually directs the first and second beams to different portions on a second lens array. The second beam with P-polarization is directed to a plurality of half-wave plates and converted into S-polarized light, which can be modulated by a liquid crystal display panel to project an image.

### BACKGROUND OF THE INVENTION

1. Field of the Invention

The present invention relates to an image projection system and a polarizing beam splitter thereof, and in particular to a polarizing beam splitter capable of shortening the convergence path of light in an image projection system.

2. Description of the Related Art

Currently, Liquid Crystal Display (LCD) projection systems using LCD panels are widely used in large screen televisions and stand-alone projectors.

A number of prior patents and articles have suggested that the unpolarized light may be separated into two polarized beams, the polarization beam is reversed and the two beams are then combined. The system is referred to as a “polarizer doubler” as it doubles the amount of light available in one polarization. This polarizer doubler generally uses a Polarizing Beam Splitter (PBS) which separates light into two polarized beams.

In U.S. Pat. No. 4,913,529 to Goldenberg et al, an incident beam of unpolarized light is directed to a polarizing beam splitter (PBS) which reflects a beam of S-polarization (perpendicular to plane of incidence) and passes a beam of P-polarization (parallel to plane of incidence). The S-polarization beam is directed through a polarization rotator (half-wave retarder plate) which rotates the beam by 90°. The two beams are then combined using a prism.

U.S. Pat. No. 5,601,351 and European Patent Application 0467-447-A1 to Brandt disclose a polarizer doubler for an image projection apparatus. It uses a polarization-sensitive beam-splitting prism and a polarization rotator which is a birefringent adhesive layer on a face of the prism. An optical integrator, positioned after the polarizer doubler, may include a “light guiding tube” (light pipe) whose entrance face is adapted to the cross-section of the beam emerging from the polarizing system and whose exit face is adapted to the shape and dimensions of the object to be illuminated. Brandt states that preferably the optical integrator is a first and second lens plate. The U.S. patent '351 states that the polarizing system is between the optical integrator and the light source.

U.S. Pat. No. 5,278,680 to Karasawa et al discloses a polarizing beam splitter (PBS) between the light source and the LCD plate. A polarization conversion device (polarizer rotator) converts the polarization of one beam. The two beams are superimposed, in one embodiment, in a prism to form a single beam.

FIG. 1A shows a typical transmissive liquid crystal display LCD projector. In FIG. 1A, the conventional LCD projector includes a light source 11, an optical polarizing module 12, an image module 16 and an optical output lens assembly 16. A color separating apparatus such as dichroic mirrors 14a, 14b separately collimated white light beams from the light source 11 into three primary color beams (i.e., red, green and blue beams). The red, green and blue beams are then individually modulated by LCDs 16, combined by a separate optical apparatus such as a prism, mirror or lens, and then projected to the screen through the optical output lens assembly 16.

The conventional optical polarizing module includes two lens arrays 121, 122, a prism PBS 123 and several half-wave plates 124. The lens arrays 121, 122 provide uniform intensity of white light from the light source 11. The prism PBS 123 and the half-wave plates 124 are used to modulate the polarization of the introduced white light, providing the required white light with a single polarization for LCD panel 16.

FIG. 1B is an enlarged schematic view of the conventional prism PBS used in FIG. 1A. The polarization of the introduced white light 1 is random, including both a P-polarization component and an S-polarization component. The conventional prism PBS 123 allows light with P-polarization to pass therethrough and reflects light with S-polarization at the diagonal interface of two prisms. P-polarized light passes through the separately disposed half-wave plates, is converted to S-polarized light and directed to the LCD panels together with the reflected S-polarized light. Thus, only the S-polarized light passes through the conventional optical polarizing module 12 in FIG. 1A to be utilized by the LCD panel.

The key weakness of the prism PBS is that the conversion efficiency of the prism PBS is dependent on the angle of incident beam. The conversion efficiency peaks at normal incidence to the incident surface of the prism PBS, with skew-ray depolarization increasing as the incident angle moves away from the normal angle. This occurs because the reflection and the transmission coefficient for each polarization changes independently with the angle of incidence. Hence, the light for the conventional prism PBS must be parallel light or as parallel as possible. After the parallel light passes through the prism, a lens assembly or a convex 13 (shown in FIG. 1A) is required to converge the parallel light beam, directing it to the following optical modules.

Due to the long convergence path required by parallel light, conventional LCD projectors are large. Furthermore, excessive light energy is lost during the light convergence process, lowering the brightness of the system.

Additionally, when using smaller LCD panels to reduce the profile of the system, the convergent light path must be lengthened to achieve the required convergence ratio. FIG. 1C shows another conventional LCD projector 10′ with a diagonally disposed mirror to fold the convergent light path. An additional mirror 18, however, dissipates light, such that the brightness of the system suffers.

Moreover, the prism PBS is expensive and has poor heat-resistance (less than 90° C.). Thus, the conventional LCD projector requires a better heat-dissipating device to cool the prism PBS 123.

In radar technology, wire grid polarizers have been used successfully to polarize long wavelength radar waves. These wire grid polarizers have also been used as reflectors. They are also well known as optical components in infrared (IR) devices, where they are used principally as transmissive polarizer elements.

A Patent (U.S. Pat. No. 4,679,910) discloses the use of a wire grid polarizer in an imaging system designed for the testing of IR cameras and other IR instruments. In this case, the application requires a beam splitter for the long wavelength infrared, in which case a wire grid polarizer is the only practical solution. The patent does not suggest utilizing for the visible range or even mention the need for a large angular aperture. Neither does it address the need for efficient conversion of light into a viewable image, nor the need for broadband performance.

Furthermore, U.S. Pat. Nos. 6,243,199 and 6,234634 to Hansen et al. teache a wire grid polarizing splitter (shown in FIG. 2) for use in an image projection system. The wire grid polarizing beam splitter has a generally parallel arrangement of thin, elongated elements 22 which interact with electromagnetic waves of a source light beam to transmit or pass light of one polarization, and reflect light of the other polarization. The relative reflection ratio and the transmission ratio of the incidence with different frequencies to the wire grid PBS depend on the thickness W₃ and the width W₁ of the elongated elements 22 and the width of the intervals W₂.

U.S. patent No. 6,452,724 to Hansen, et al. teaches a polarizing device has an arrangement of generally parallel elements disposed in an unpolarized source light beam for transmitting polarizations perpendicular to the elements and reflecting polarizations parallel to the elements. The elements may be disposed at substantially any incidence angle and may reflect the reflected beam at substantially any angle. A polarizer apparatus may also have a mirror or the like for redirecting or recapturing the transmitted or reflected beam so they have similar directions or are directed to a common area. The device may also have a wave plate or the like for changing the polarization of the transmitted or reflected beams so they have the same polarization. These references demonstrate that it is known in the art that wire grid arrays can function as polarizers.

### SUMMARY OF THE INVENTION

Accordingly, an object of the present invention is to provide a transmissive LCD projector using the wire grid polarizer as a PBS for the convergent light source to shorten the convergent light path and reduce the profile thereof.

The present invention provides an optical polarizing module having a polarizing beam splitter (PBS) and a mirror. The polarizing beam splitter reflects light with a first polarization , defining a first beam, and passes light with a second polarization. The mirror is disposed near the polarizing beam splitter with a predetermined acute angle to reflect light with the second polarization, passing through the polarizing beam splitter again to form a second beam.

In a preferred embodiment, the polarizing beam splitter is a wire grid polarizing beam splitter.

Moreover, the optical polarizing module further includes a first lens array having a plurality of first lens cells facing the polarizing beam splitter and disposed near the polarizing beam splitter to couple the reflected first and second beams. A second lens array has a first surface facing the first lens array and a plurality of second lens cells on the opposite surface. The second lens array is disposed parallel to the first lens array with a first distance. The second lens array has a plurality of elongated half-wave plates disposed on the first surface to convert the direction of the first polarization of light in the second beam directed from the first lens array into the direction of the second polarization.

Moreover, the first and second lens arrays are parallel to an intersection of the extending planes of the polarizing beam splitter and the mirror. the F-numbers of the first and second lens arrays are between f/1.5 and f/3. The first lens array and the second lens array have the same aspect ratio and “M×N” pieces of lens cells according to the required uniformity of the system.

In a preferred embodiment, the relationship between the first distance (t) and the predetermined included angle (θ) is

$$θ = \frac{{d}_{2}}{2 t} ,$$

wherein d₂ is the length of the second lens cell.

Moreover, the half-wave plates are parallelly disposed on the first surface. The width of each half-wave plate is equal to half the length of each second lens cell. The intervals of the half-wave plates are equal to half the length of each second lens cell. Each second lens cell is divided into an upper portion and a lower portion by a center line, and the half-wave plates are disposed within the upper portions on the first surface parallel to the intersection.

The present invention also provides an image projection system, including a light source, an optical polarizing module, a display module and an optical output lens assembly. The light source provides a visible convergent light beam. An optical polarizing module is disposed near the light source. The optical polarizing module includes a polarizing beam splitter to reflect light with S-polarization, forming a first beam, and transmit light with P-polarization. A mirror is disposed near the WG-PBS at a predetermined acute angle to reflect S-polarization light, through the WG-PBS again and forming a second beam. A first lens array couples the first and second beams and individually directs the first and second beams to different portions on a second lens array. The second beam with P-polarization is directed to a plurality of half-wave plates and converted into S-polarized light . The display module modulates the first and second beams provided by the optical polarizing module in accordance with image data fed thereto. The optical output lens assembly directs light to the display module and projects the modulated light.

In a preferred embodiment, the polarizing beam splitter is a wire grid polarizing beam splitter (WG-PBS). The incident angle between the light beam and the WG-PBS is between 35° and 55°.

Moreover, the optical polarizing module further includes a first lens array having a plurality of first lens cells facing the polarizing beam splitter and disposed near the polarizing beam splitter to couple the reflected first and second beams. A second lens array has a first surface facing the first lens array and a plurality of second lens cells on the opposite surface. The second lens array is disposed parallel to the first lens array with a first distance. The second lens array has a plurality of elongated half-wave plates disposed on the first surface to convert the direction of the first polarization of light in the second beam directed from the first lens array into the direction of the second polarization.

Moreover, the first and second lens arrays are parallel to an intersection of the extending planes of the polarizing beam splitter and the mirror. The first and second lens arrays are used in an optical system with the F-numbers between f/1.5 and f/3. The first lens array and the second lens arrays have the same aspect ratio and “M×N” pieces of lens cells according to the required uniformity of the system.

In a preferred embodiment, the relationship between the first distance (t) and the predetermined angle (θ) is

$$θ = \frac{{d}_{2}}{2 t} ,$$

wherein d₂ is the length of longer side of each second lens cell.

Moreover, the half-wave plates are parallelly disposed. The width of each half-wave plate is equal to half the length of each second lens cell. The intervals of the half-wave plates are equal to half the length of each second lens cell. Each second lens cell is divided into an upper portion and a lower portion by a center line, and the half-wave plates are disposed within the upper portions on the first surface parallel to the intersection.

Moreover, the display module is a liquid crystal display, and the distance between the second lens array and the liquid crystal display defines a second distance (l). Furthermore, the relationship between the length of the first lens cell (d₁) and the length of the second lens cells (d₂) is

$$\frac{{d}_{2}}{{d}_{1}} = \frac{l}{l + t} .$$

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a schematic view of a conventional transmissive LCD projector;

FIG. 1B is a schematic view of the prism polarizing beam splitter used in the conventional LCD projector in FIG. 1A;

FIG. 1C is a schematic view of another conventional transmissive LCD projector;

FIG. 2 is a schematic view of the wire grid polarizing beam splitter as referenced in the Prior Art;

FIG. 3 is a schematic view of the transmissive LCD projector of the invention;

FIG. 4A is an enlarged schematic view of the optical polarizing module shown in FIG. 3.

FIG. 4B is a schematic view showing the S-polarized light passing through the optical polarizing module of the invention.

FIG. 4C is a schematic view showing the P-polarized light passing through the optical polarizing module of the invention.

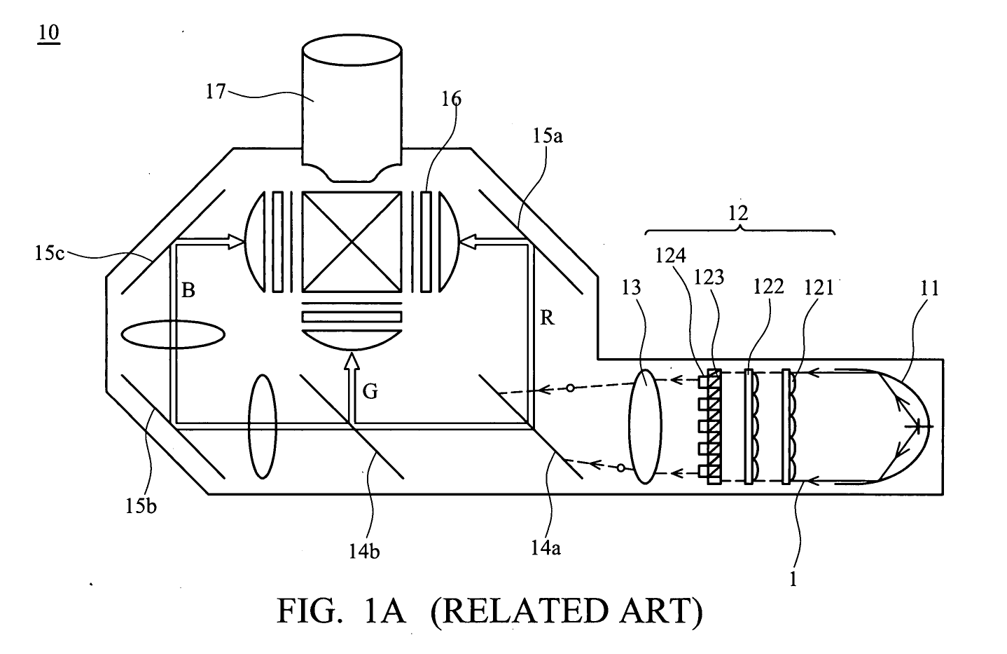

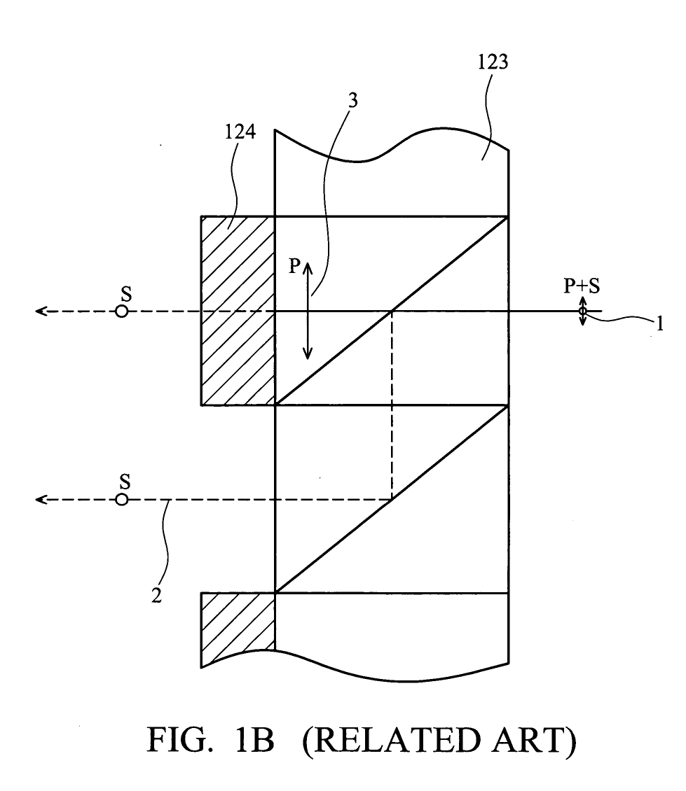

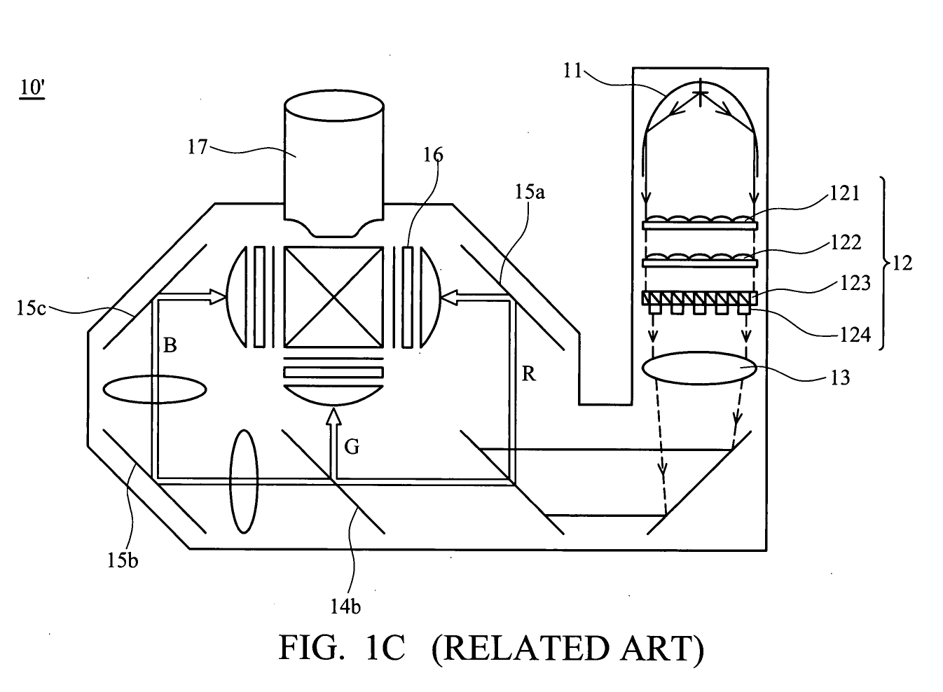

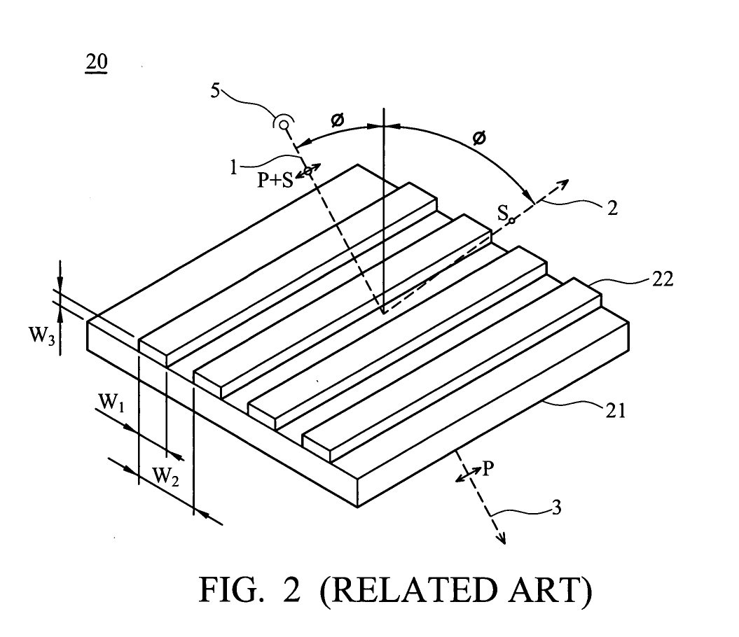

### DETAILED DESCRIPTION OF THE INVENTION

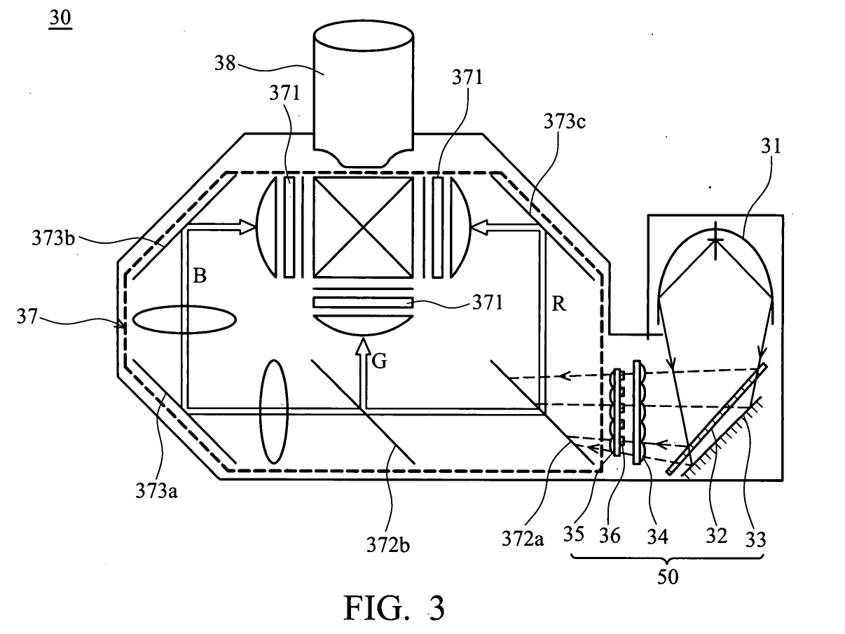

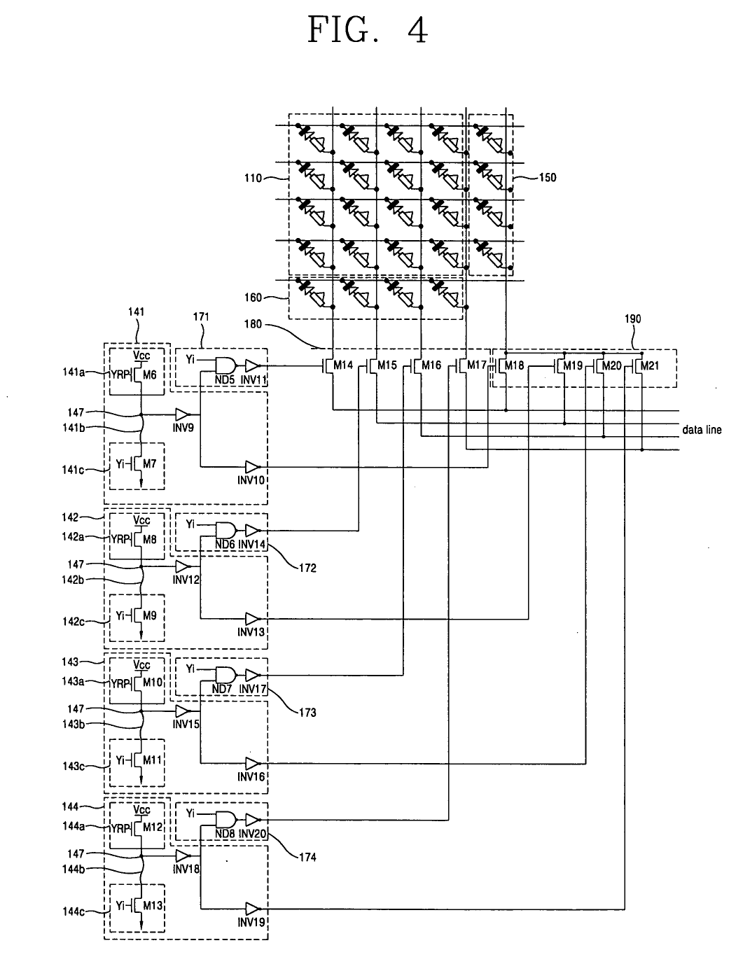

FIG. 3 shows a transmissive LCD projector of the invention. In FIG. 3, the image projection system 30 includes a convergent light source 31, optical polarizing module 50, display module 37 and optical output lens assembly 38. The light source 31 includes a lamp and an elliptic reflector to provide a visible convergent light beam. The optical polarizing module 50 is disposed near the light source 31. The optical polarizing module 50 converts the polarization of the convergent light beam into a predetermined polarization and couples the convergent light into the display module 37, which splits the convergent light beam into three sub-beams (RGB). The polarized sub-beams are directed through light filters 372a, 372b and respectively modulated by red, green and blue transmissive imagers 371, such as LCD light valves, according to the input image data. Finally, the modulated RGB sub-beams are combined and projected through an optical lens assembly 38.

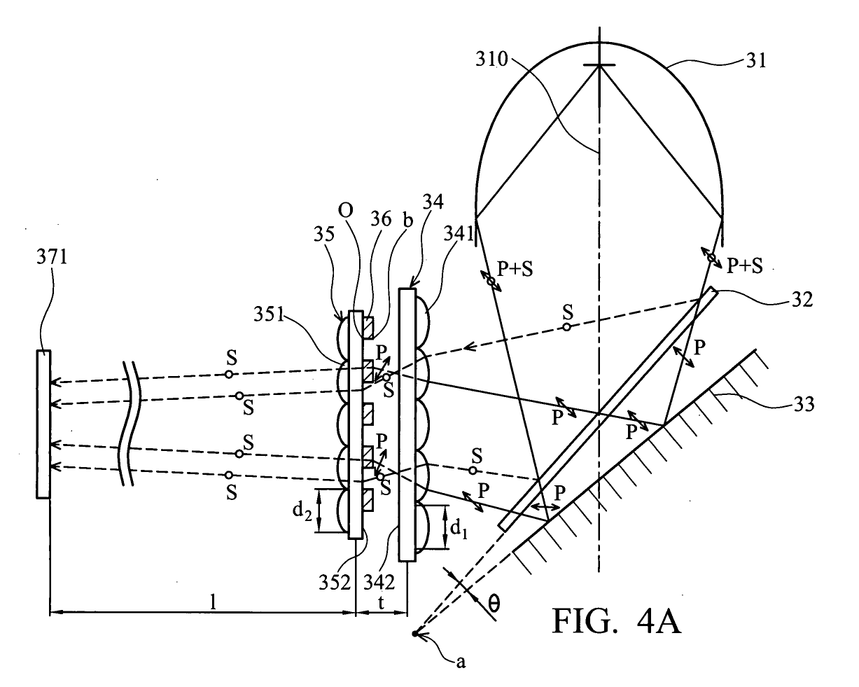

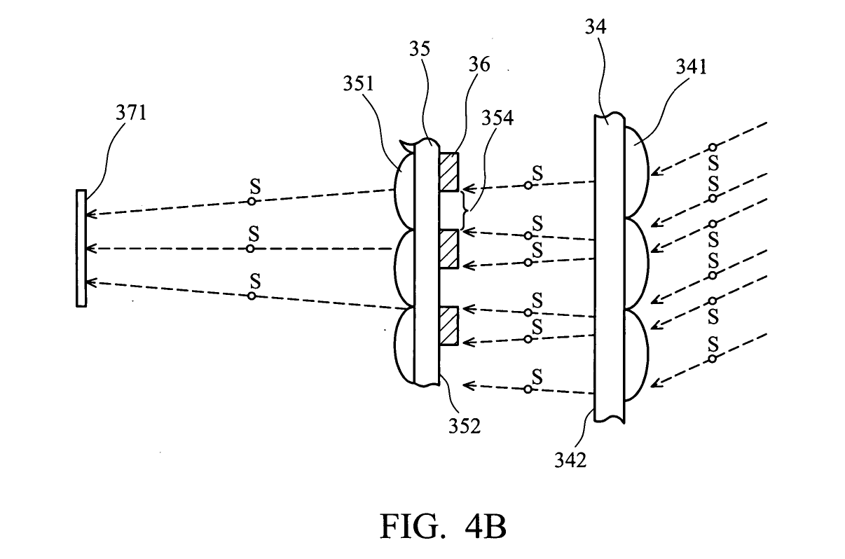

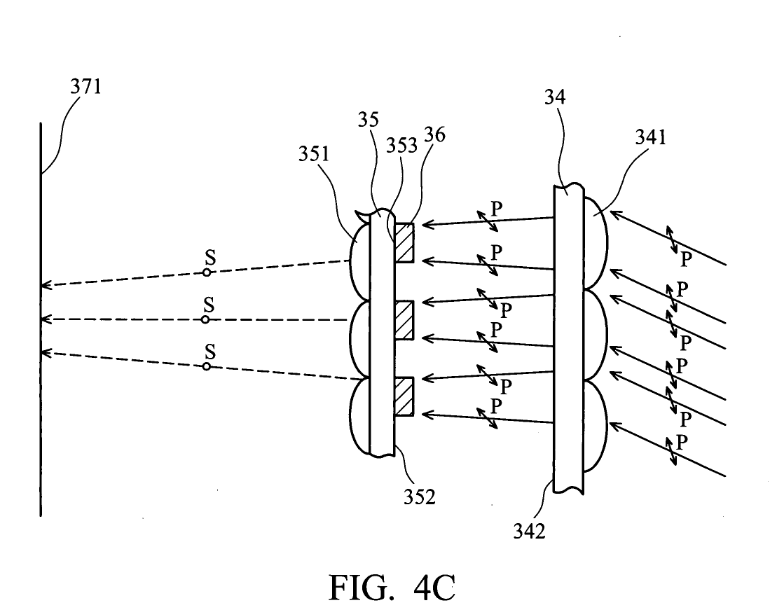

FIG. 4A is an enlarged schematic view of the optical polarizing module shown in FIG. 3. In FIGS. 3 and 4A, the optical polarizing module 50 has a wire-grid polarization beam splitter (WG-PBS) 32. The incident angle between the convergent light beam (P+S) and the WG-PBS 32 is between 35° and 55°. A mirror 33 is disposed near the WG-PBS 32 at a predetermined included angle θ, and the intersection of the extending planes of the WG-PBS 32 and the mirror 33 is defined as a predetermined axis (a).

The optical polarizing module 50 of the invention further includes a first lens array 34, a second lens array 35 and a plurality of elongated half-wave plates 36. The first lens array 34 and the second lens array 35 are both parallel to the predetermined axis (a). The first lens array 34 is diagonally disposed near the WG-PBS 32 opposite to the mirror 33 to couple the first light beam (S) and the second light beam (P) individually reflected from the WG-PBS 32 and the mirror 33. The first lens array 34 has a plurality of first lens cells 341 on the surface facing the WG-PBS 32.

The second lens array 35 is parallel to the first lens array 34 and separated by a first distance (t) and has a first surface 352 and a plurality of second lens cells 352 on the opposite surface. The relationship between the first distance (t) and the predetermined included angle (θ) is

$$θ \approx tan θ = \frac{{d}_{2}}{2 t} \qquad ( A ) ,$$

wherein d₂ is the length of the plurality of second lens cells.

Furthermore, the half-wave plates 36 are disposed on the first surface 352 and separated by the same intervals. The half-wave plates 36 convert the light with the first polarization in the second light beam directed from the first lens array 34 into light with the second polarization.

In a preferred embodiment, the first and second lens arrays 34,35 have the same matrix of lens cells, such as the first and second lens array 34, and 35 both have MxN pieces of lens cells, and the column number M and the row number N are determined according to required light uniformity. Moreover, the ratio of the length to the width of each lens cell 341, 351 is 4:3 or 16:9.

According to the preferred embodiment, the first and second lens arrays 34, and 35 are used in an optical system with F-number between f/1.5 and f/3. The half-wave plates 36 are long, thin optical lenses attached to the first surface 352 of the second lens array 35 to convert the polarization of light. The half-wave plates 36 are parallelly arranged and separated by the same intervals. The separated intervals and the width of the elongated half-wave plates 36 are equal to half the width of longer side of the second lens cells 351. The major axis (b) of the half-wave plates 36 are parallel to the predetermined axis (a) . Moreover, the second lens cells 351 in the same row of the second lens array 35 are divided into a upper portion 353 and a lower portion 354. The half-wave plates 36 are disposed on the upper portion 353 of each row of second lens cells 351.

In order to precisely focus the light on the LCD 371 of the display module, the relationship between the length of the plurality of first lens cells (d₁) and the length of the plurality of second lens cells (d₂) must satisfy the following equation:

$$\frac{{d}_{2}}{{d}_{1}} = \frac{l}{l + t} \qquad ( B ) ,$$

wherein the first distance (t) is the interval between the first lens array 34 and the second lens array 35, and the second distance (l) is the distance between the LCD panel 371 and the second lens array 35.

Furthermore, the relationship between the focal length of the plurality of first lens cells (f₁) and the focal length of the plurality of second lens cells (f₂) should satisfy the following equation:

$$\begin{matrix}\frac{1}{{f}_{1}} = \frac{1}{t} - \frac{1}{l + t} & ( C ) \\ \frac{1}{{f}_{2}} = \frac{1}{t} + \frac{1}{l} & ( D )\end{matrix}$$

In FIG. 4A, the light emitted from the lamp is reflected by the elliptic reflector to provide a visible convergent light beam. The convergent light includes P-polarization and S-polarization components. When the convergent light (P+S) impinges on the WG-PBS 32, the WG-PBS 32 reflects the S-polarized light with the polarization vector perpendicular to the surface of WG-PBS 32, forming a first beam (S-polarized light beam), and transmits P-polarized light with the polarization vector parallel to the surface of WG-PBS 32. Then, the P-polarized light beam is reflected by the mirror 33 and passes through the WG-PBS 32 again, forming a second beam (P-polarized light beam).

FIG. 4B shows the S-polarized light passing through the optical polarizing module of the invention. FIG. 4C shows the P-polarized light passing through the optical polarizing module of the invention. The convergent light beam (P+S) is divided into two light beams with different polarizations and separately reflected to the first lens array 34 by the WG-PBS 32 and the mirror 33 due to the included angle θ between the WG-PBS 32 and the mirror 33. Thus, the incident angles of the separated first and second light beams are different. When the S-polarized first light beam and the P-polarized second light beam pass through the first lens array 34, the first and second light beams are refracted with different angles and transformed to the same polarization.

In FIGS. 4A and 4B, the convergent S-polarized light beam passes through the first lens array 34, is divided into a plurality of sub-beams and focused on the lower portion 354 of each second lens cell 351. The S-polarized beam is unified by the second lens array 35, entering the display module and focusing on the imagers 371 after passing through the second lens array 35. In FIGS. 4A and 4C, the convergent P-polarized light beam passes through the first lens array 34, is divided into a plurality of sub-beams and focused on the upper portion 353, or the half-wave plates 36, of each second lens cell 351. The P-polarized light of the second light beam is converted into S-polarized by the half-wave plates 36″ to “In FIGS. 4A and 4C, the convergent P-polarized light beam passes through the first lens array 34, is divided into a plurality of sub-beams and focused on the upper portion 353 , i.e. to the half-wave plates 36 of each second lens cell 351, thus the P-polarized light of the second light beam is converted into S-polarized by the half-wave plates 36. The second light beam is also unified by the second lens array 35 and directed into the display module, focusing on the imagers 371 after passing through the second lens array 35. Thus, the convergent light beam are modulated to have the same polarization (S-polarization).

Accordingly, due to the convergent angle and the incident angle of the WG-PBS used in the optical polarizing module of the present invention, the light converting efficiency is better than the conventional prism PBS. Furthermore, because the WG-PBS is fabricated by conventional semiconductor processes, the WG-PBS is cost effective, easily manufactured and can tolerate higher operating temperature.

The optical polarizing module of the present invention uses the convergent light source to shorten the convergent light path, instead of using an additional lens assembly, thus greatly increasing the output illumination and reducing the profile of the LCD projector.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical polarizing module, comprising:
a polarizing beam splitter, reflecting light with a first polarization, defining a first beam, and passing light with a second polarization;
a mirror, disposed near the polarizing beam splitter with a predetermined acute angle to reflect light with the second polarization, passing through the polarizing beam splitter again and forming a second beam;
a first lens array, having a plurality of first lens cells facing the polarizing beam splitter and disposed near the polarizing beam splitter to couple the first beam and the second beam; and
a second lens array with a first surface facing the first lens array and a plurality of second lens cells on the opposite side, wherein the second lens array is disposed parallel to the first lens array at a first distance, the second lens array has a plurality of elongated half-wave plates disposed on the first surface to convert the direction of the first polarization of light in the second beam directed from the first lens array into the direction of the second polarization.

2. The module as claimed in claim 1, wherein the polarizing beam splitter is a wire grid polarizing beam splitter.

3. The module as claimed in claim 1, wherein the first and second lens arrays are used in an optical system with F-number between f/1.5 and f/3.

4. The module as claimed in claim 1, wherein the first lens array and the second lens array have the same aspect ratio.

5. The module as claimed in claim 1, wherein the first and second lens arrays are parallel to an intersection of the extending planes of the polarizing beam splitter and the mirror.

6. The module as claimed in claim 5, wherein an elongated axis of each half-wave plate is parallel to the intersection.

7. The module as claimed in claim 1, wherein the relationship between the first distance (t) and the predetermined included angle (θ) is
$$θ = \frac{{d}_{2}}{2 t} ,$$
wherein d₂ is the length of the longer side of the second lens cells.

8. The module as claimed in claim 1, wherein the half-wave plates are disposed on the first surface parallel to each other at the same intervals.

9. The module as claimed in claim 8, wherein the width of each half-wave plate is equal to half the length of the longer side of the second lens cells.

10. The module as claimed in claim 9, wherein the intervals of the half-wave plates are equal to half the length of the plurality of second lens cells.

11. The module as claimed in claim 10, wherein a central line divides each second lens cell into an upper portion and a lower portion, and the half-wave plates are disposed within the upper portions on the first surface.

12. An image projection system, comprising:
a light source providing a visible light beam;
an optical polarizing module disposed near the light source in the light beam, comprising:
a polarizing beam splitter, reflecting light with a first polarization, defining a first beam, and passing light with a second polarization;
a mirror, disposed near the polarizing beam splitter with a predetermined acute angle to reflect light with the second polarization, passing through the polarizing beam splitter again and forming a second beam;
a first lens array, having a plurality of first lens cells facing the polarizing beam splitter and disposed near the polarizing beam splitter to couple the first beam and the second beam; and
a second lens array with a first surface and a plurality of second lens cells on the opposite side, wherein the second lens array is disposed parallel to the first lens array with a first distance; and
a plurality of elongated half-wave plates disposed on the first surface to convert the direction of the first polarization of light in the second beam directed from the first lens array into the direction of the second polarization;
a display module, displaying an image in accordance with image data fed thereto to modulate the first and second beams provided by the optical polarizing module; and
an optical output lens assembly, directing light from the display module and projecting the modulated light.

13. The image projection system as claimed in claim 12, wherein the light source is a convergent light source.

14. The image projection system as claimed in claim 12, wherein the polarizing beam splitter is a wire grid polarizing beam splitter.

15. The image projection system as claimed in claim 12, wherein the incident angle between the light beam and the polarizing beam splitter is between 35° and 55°.

16. The image projection system as claimed in claim 12, wherein the first and second lens arrays are used in an optical system with the F-numbers between f/1.5 and f/3.

17. The image projection system as claimed in claim 12, wherein the first lens array and the second lens arrays have the same aspect ratio.

18. The image projection system as claimed in claim 12, wherein the first surface of the second lens array faces the first lens array.

19. The image projection system as claimed in claim 1, wherein the first and second lens arrays are parallel to an intersection of the extending planes of the polarizing beam splitter and the mirror.

20. The image projection system as claimed in claim 19, wherein an elongated axis of each half-wave plate is parallel to the intersection.

21. The image projection system as claimed in claim 12, wherein the relationship between the first distance (t) and the predetermined angle (θ) is
$$θ = \frac{{d}_{2}}{2 t} ,$$
wherein (d₂) is the length of the longer side of the second lens cells.

22. The image projection system as claimed in claim 12, wherein the half-wave plates are disposed on the first surface parallel to each other at the same intervals.

23. The image projection system as claimed in claim 22, wherein the width of each half-wave plate is equal to half the length of the longer side of the second lens cells.

24. The image projection system as claimed in claim 23, wherein the intervals of the half-wave plates are equal to half the length of the plurality of second lens cells.

25. The image projection system as claimed in claim 24, wherein a central line divides each second lens cell into an upper portion and a lower portion, and the half-wave plates are disposed within the upper portions on the first surface.

26. The image projection system as claimed in claim 12, wherein the display module is a liquid crystal display, and the distance between the second lens array and the liquid crystal display defines a second distance (l).

27. The image projection system as claimed in claim 26, wherein the relationship between the length of the plurality of first lens cells (d₁) and the length of the plurality of second lens cells (d₂) is
$$\frac{{d}_{2}}{{d}_{1}} = \frac{l}{l + t} .$$
